(19) United States
(12) Patent Application Publication
(10) Pub. No.: US 2005/0273467 A1
(43) Pub. Date: Dec. 8, 2005

(54) Method of transferring electronic data interchange (EDI) data

(76) Inventor: Michael J. Gardner, Findlay, OH (US)

Correspondence Address: HARNESS, DICKEY & PIERCE, P.L.C., P.O. BOX 828, BLOOMFIELD HILLS, MI, 48303, US

(21) Appl. No.: 11/134,171

(22) Filed: May 20, 2005

Related U.S. Application Data
(60) Provisional application No. 60/573,772, filed on May 21, 2004.

(51) Int. Cl. G06F 7/00

(52) U.S. Cl. 707/100

(57) ABSTRACT

An automated electronic data interchange system is provided for electronically sending electronic data interchange data to a plurality of recipients. A datastore stores address information for a plurality of recipients. A parser module receives data formatted in accordance with Electronic Data Interchange (EDI) protocol standards and parses the data into a plurality of recipient files, wherein the plurality of files correspond to the plurality of recipients. A transmitter module having access to the address information of the datastore and transmits each of the recipient files to a corresponding recipient at the address obtained from the datastore.

### CROSS-REFERENCE TO RELATED APPLICATIONS

This application claims the benefit of U.S. Provisional Application No. 60/573772, filed on May 21, 2004. The disclosure of the above application is incorporated herein by reference.

### FIELD OF THE INVENTION

The present invention generally relates to electronic data transfer. The present invention more particularly relates to the transfer of Electronic Data Interchange (EDI) data.

### BACKGROUND OF THE INVENTION

Common standardized data formats for information exchange in business environments are known. The Electronic Data Interchange (EDI) family of data-formats is one example. In EDI, the electronic equivalents of common business documents, such as requests for quotes, purchase orders and invoices, are transmitted electronically between the computers of trading partners. These electronic documents are given standardized electronic formats and numbers (referred to as ANSI X12 standards), so everyone involved can correctly interpret the information that is sent to them.

EDI is commonly used by motor vehicle original equipment manufacturers (OEMs) to distribute various information relating to their products. The OEMs will transfer EDI data to a third party that will hold the data. The third party will allow authorized suppliers of the OEM to access, read and download the data. The third party is typically compensated by these authorized suppliers for access to the data. A need remains in the pertinent art for an efficient way to transfer data without the intervention of a third party.

### SUMMARY OF THE INVENTION

An automated electronic data interchange system is provided for electronically sending electronic data interchange data to a plurality of recipients. A datastore stores address information for a plurality of recipients. A parser module receives data formatted in accordance with Electronic Data Interchange (EDI) protocol standards and parses the data into a plurality of recipient files, wherein the plurality of files correspond to the plurality of recipients. A transmitter module having access to the address information of the datastore and transmits each of the recipient files to a corresponding recipient at the address obtained from the datastore.

In one aspect of the system the parser module parses the data according to parameters defined by EDI protocol standards, and wherein the parameters can be at least one of a supplier code, a transaction code, and a transaction date.

In another aspect of the system, an address module receives a plurality of addresses from a user and stores the plurality of addresses in a plurality of subdirectories of the datastore, wherein each subdirectory of the plurality of subdirectories is designated to a recipient of the plurality of recipients.

In yet another aspect of the system, a zip module receives the plurality of recipient files and condenses the plurality of recipient files into a plurality of zip files before transmitting.

In still another aspect of the system, an encryption module encrypts the plurality of recipient files or the plurality of zip files according to an encryption method and an encryption key and generates a plurality of encrypted files to be transmitted.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram depicting a typical Electronic Data Interchange (EDI) data transfer environment according to the present invention;

FIG. 2 is a data flow diagram illustrating a first subpart of an EDI data transfer module; and

FIG. 3 is a data flow diagram illustrating a second subpart of the EDI data transfer module.

### DETAILED DESCRIPTION OF THE PREFERRED EMBODIMENTS

The following description of the preferred embodiment is merely exemplary in nature and is in no way intended to limit the invention, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

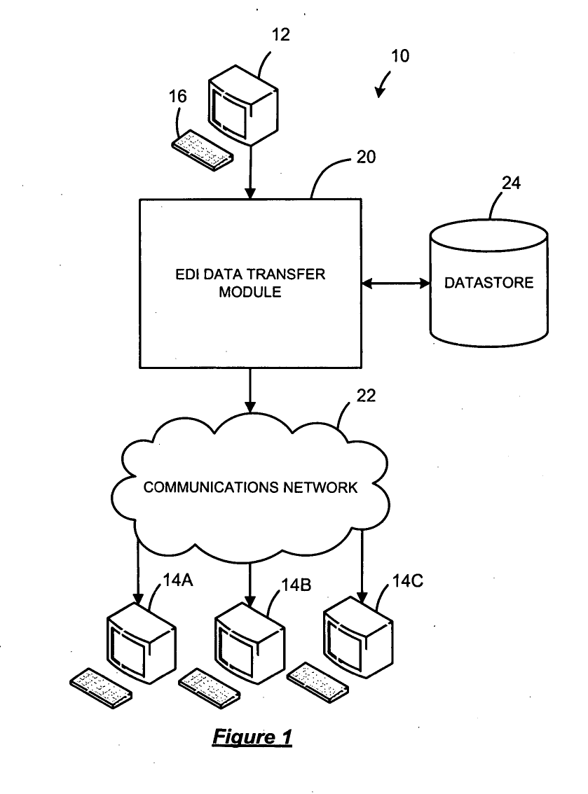

Referring to FIG. 1, an automatic electronic data interchange system incorporating the present teachings is shown generally at 10. The system 10 is generally shown to include a host computer 12. The system 10 is further shown to include a plurality of recipient computers 14A, 14B, and 14C. As will be discussed further below, the host computer 12 typically receives electronic data formatted according to Electronic Data Interchange (EDI) standards from a communications network. The host computer 12 is shown associated with an input device 16 used by a user of the host computer to enter data parameters. As can be appreciated, the host computer 12 can have more than one input device 16. Such devise can be a mouse, a keyboard, or a scanner.

The host computer 12 of the present teachings includes a processor (not shown) operable to execute one or more set of instructions contained in a software module. An EDI data transfer module 20 is executed by the processor of the host computer to automatically parse and selectively communicate electronic data to the recipient computers 14A-C via a communications network 22. The EDI data transfer module 20 is further shown to communicate with a datastore 24. The data store can be at least one of Random Access Memory (RAM), Read Only Memory (ROM), a cache, a stack or the like which may temporarily or permanently store electronic data of the system. Insofar as the present invention is concerned, communications between the host computer 12 and the communications network 22 and the recipient computers 14A-C and the communications network 22 will be understood to be conventional.

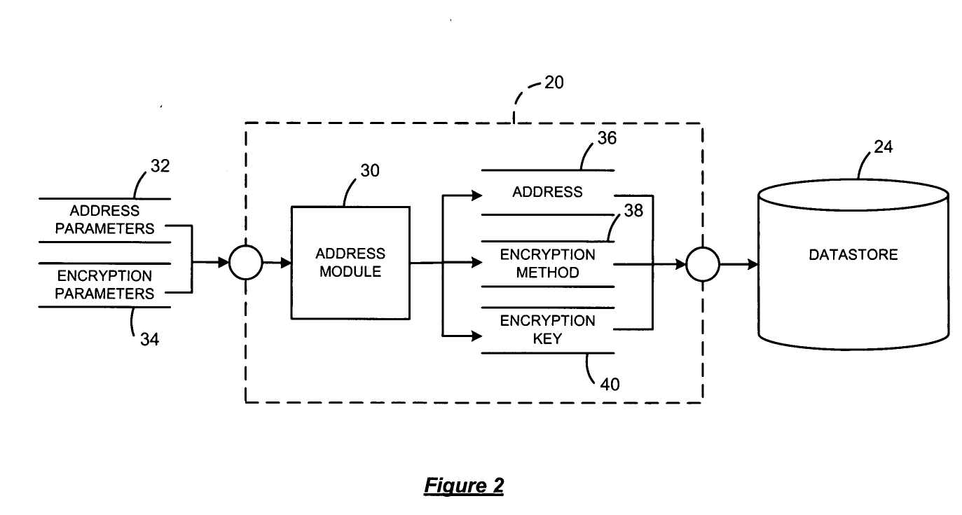

With continued reference to FIG. 1 and additional reference to the data flow diagram of FIG. 2, a subpart of the EDI data transfer module 20 will be further described. The EDI data transfer module 20 can include an address module 30 operable to receive data parameters. The data parameters can be transmitted to the address module 30 by a recipient computer 14A-C via a communications network 22 or entered by a user of the host computer 12 by an input device 16 via a user interface. Such data parameters can be electronic addresses 32 corresponding to recipients of the recipient computers 14A-C. As will be described in detail below, an email including EDI data can be generated and sent to the electronic addresses 32. The address module 30 can also receive encryption parameters 34 corresponding to various encryption methods and encryption keys used by recipients of the recipient computers 14A-C. As will be described in more detail below, an encryption method is used to encrypt the elements of an email before the email is generated. An encryption key can be used by the recipient of the email to decrypt the elements of the email.

The address module 30 is further operable to process the data parameters and store for each recipient an address 36, an encryption method 38, and/or an encryption key 40 in a datastore 24. The datastore 24 can include a plurality of subdirectories. Each subdirectory of the data store can be designated to a recipient of recipient computers 14A-C. If a subdirectory does not exist for a recipient, the address module 30 will create a subdirectory in recipient's name. The address module 30 stores an address in a subdirectory named ADDRESS of the directory designated to the recipient. The address module 30 stores associated encryption parameters in a subdirectory named ENCRYPT of the directory designated to the recipient. If an encryption method 38 and encryption key 40 are not entered or transmitted for a recipient, a directory is not created, as shown below for recipient 3. A simplified form of example subdirectories appears below.

| RECIPIENT | SUBDIRECTORY | DATA |
|---|---|---|
| Recipient 1 | C:\rec1\ADDRESS | rec1@rec1.com |
| Recipient 1 | C:\rec1\ENCRYPT | PGP, key |
| Recipient 2 | C:\rec2\ADDRESS | rec2@rec2.com |
| Recipient 2 | C:\rec2\ENCRYPT | RSA, key |
| Recipient 3 | C:\rec3\ADDRESS | rec3@rec3.com |

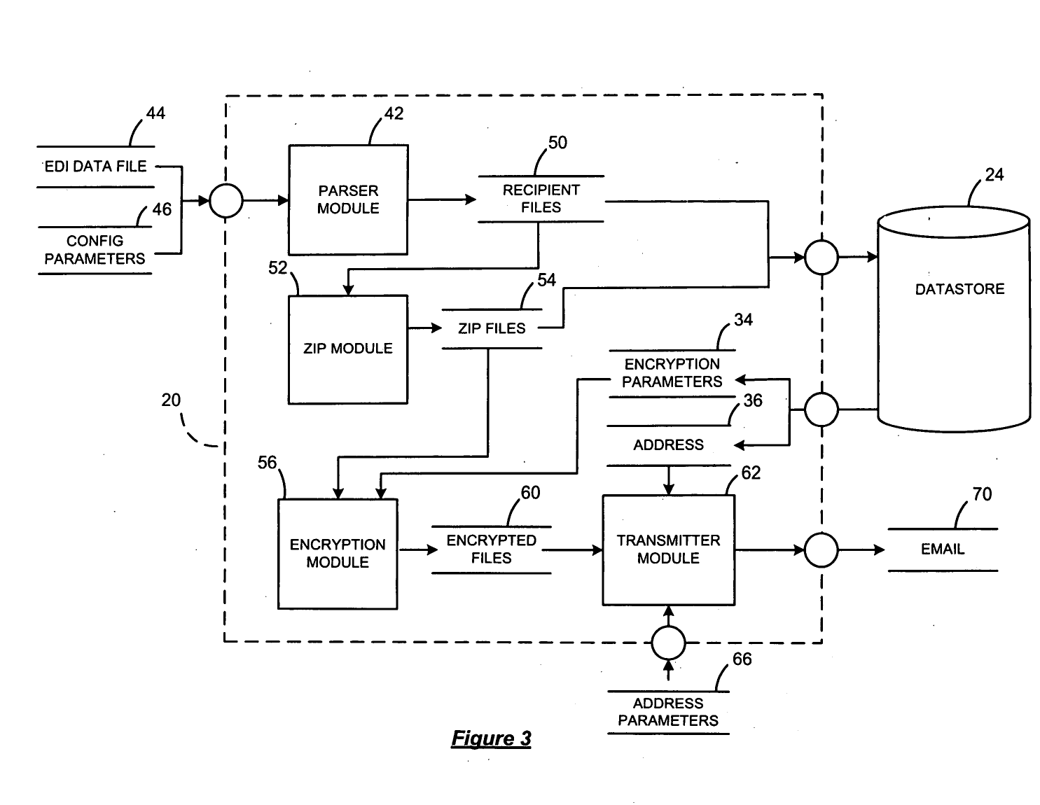

With continued reference to FIG. 1 and additional reference to the data flow diagram of FIG. 3, a second subpart of the EDI data transfer module 20 will be further described. The EDI data transfer module 20 can also include a parser module 42 and a transmitter module 62. The parser module 42 is responsible for receiving EDI data from a communications network 22 and parsing the EDI data according to configuration parameters 46 entered by a user of the host computer. The transmitter module 62 is responsible for generating emails to electronic addresses of recipients according to the data parsed by the parser module 42. A user of the host computer can schedule the parser module and the transmitter module to run immediately, on a daily basis, or on a weekly basis. Optionally, the EDI data transfer module 20 can include a zip module 52 and/or an encryption module 56. The zip module 52 is responsible for condensing the data parsed by the parser module using a zip utility function. The encryption module 56 is responsible for encrypting the data parsed by the parser module 42 using a specified encryption method. The details of the modules of the EDI data transfer module 20 will be discussed below.

A parser module 42 is receptive of input parameters that may be entered by a user of the host computer via an input device 16 or transmitted via a communications network 22. The input parameters can be a data file formatted according to EDI standards 44 and a plurality of configuration parameters 46. The parser module 42 parses the EDI data file into a plurality of recipient files 50. The parser module 42 may be configured to parse particular data for a specific recipient via configuration parameters 46. Such configuration parameters 46 are defined by the EDI data protocol standards and can be a supplier name, a transaction code, and a transaction date. For example, the parser module can be configured to parse supplier data corresponding to a supplier identified by a supplier name. The parser module can be further configured to parse supplier data for a specific transaction on a specific data corresponding to a specific supplier identified by a supplier name.

In an exemplary embodiment, the parser module 42 traverses through each line of the EDI data file 44 searching for a string of characters defined by the configuration parameters 46. The string of characters can signal the beginning line and end line of a data record corresponding to a recipient. The string of characters can also signal the type of data record contained within the beginning line and the end line and a date of the data record. Once, a match for the string of characters is found, the pertinent data from the line and in some cases the lines following the string are extracted from the data file and stored in a recipient file. One skilled in the art may envision other methods of parsing, this method is merely exemplary in nature and is in now way intended to limit the present teachings,

After parsing the recipient files 50 from the EDI data file 44, the parser module 42 stores in the datastore 24 each recipient file of the plurality of recipient files 50 under a subdirectory of a directory designated to a recipient of the file. The subdirectory is named by a date. The recipient files 50 can be stored as MMDDYY.TT where MM is the month, DD is the day, YY is the year, and TT is the transaction type. Multiple recipient files can be stored for a single recipient. For example, a simplified form of subdirectories may appear as follows.

| RECIPIENT | SUBDIRECTORY | DATA |
|---|---|---|
| Recipient 1 | c:\rec1\01012005\ | 01012005.806 |
| Recipient 1 | c:\rec1\01012005\ | 01012005.830 |
| Recipient 2 | c:\rec2\02012005 | 02012005.830 |
| Recipient 2 | c:\rec2\02022005 | 02022005.806 |

Optionally, the parser module 42 can transfer the plurality of recipient files 50 to a zip module 52. A zip module 52 receives the plurality of recipient files 50 as input and condenses the size of the data in the files to a more manageable size using a zip utility function. Each recipient file of the plurality of recipient files 50 is converted to a zip file. The zip module 52 further stores a plurality of zip files 54 in designated subdirectories of the datastore 24. The subdirectories can be the same subdirectories as the subdirectories of the recipient files. The plurality of zip files 54 can be stored by MMDDYY.TT.ZIP where ZIP is the zip utility file extension.

Optionally, the zip module 52 can transfer the plurality of zip files 54 to an encryption module 56. The encryption module 56 receives the plurality of zip files 54 as input and generates a plurality of encrypted files 60 as output. More specifically, for each zip file of the plurality of zip files 54, the encryption module 56 retrieves an encryption method and an encryption key from a subdirectory of the datastore 24 designated to the recipient of the zip file and encrypts the zip file according to the encryption method and encryption key. If encryption parameters 34 do not exist for a recipient, the corresponding zip file is not encrypted. The plurality of encrypted files 60 can be transferred to a transmitter module 62 or alternatively, stored in subdirectories of the datastore 24 (data flow not shown). The subdirectories can be the same subdirectories as the subdirectories corresponding to the plurality of zip files.

Alternatively, the encryption module 56 can receive a plurality of recipient files 50 generated from the parser module 42 or stored in the datastore 24 (data flow not shown). For each recipient file of the plurality of recipient files 50, encryption module 56 retrieves an encryption method and an encryption key stored in a subdirectory of the datastore 24 and encrypts the recipient file according to the encryption method and encryption key. If encryption parameters 34 do not exist for a recipient, the corresponding recipient file is not encrypted. The plurality of encrypted files 60 can be transferred to a transmitter module 62 or alternatively, stored in subdirectories of the datastore 24. The subdirectories can be the same subdirectories as the subdirectories corresponding to the plurality of recipient files 50.

A transmitter module 62 is receptive of electronic address parameters 66 entered by a user of the host computer 12 via an input device 16. Alternatively, the transmitter module can retrieve electronic addresses 36 stored in a subdirectory of the datastore 24. Each electronic address corresponds to a recipient of the recipient computers. The transmitter module 62 generates emails 70 to the electronic addresses 36 or 66. The transmitter module 62 can transmit as attachments of the emails 70 recipient files 50, zip files 54, or encrypted files 60 corresponding to the recipients of the emails. In an exemplary embodiment, when scheduled to execute, the transmitter module 62 traverses through the subdirectories of the datastore 24 and retrieves the files stored for a specified date and/or specified recipient and attaches the files to the emails 70. Alternatively, the transmitter module 62 can receive a plurality of encrypted files 60 from the encryption module 56 and generate emails 70 to the electronic addresses 36 or 66. The emails 70 can include encrypted files 60 as attachments.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. An automated electronic data interchange system, comprising:
a datastore operable for storing address information for a plurality of recipients;
a parser module adapted to receive data formatted in accordance with Electronic Data Interchange (EDI) protocol standards and operable to parse the data into a plurality of recipient files, wherein the plurality of files correspond to the plurality of recipients; and
a transmitter module having access to the address information of the datastore and operable to transmit each of the recipient files to a corresponding recipient at the address obtained from the datastore.

2. The system of claim 1, wherein the parser module is operable to parse the data according to parameters defined by EDI protocol standards, and wherein the parameters can be at least one of a supplier code, a transaction code, and a transaction date.

3. The system of claim 1, wherein the parser module is operable to parse the data at a scheduled time.

4. The system of claim 1, further comprising an address module adapted to receive a plurality of addresses from a user, operable to store the plurality of addresses in a plurality of subdirectories of the datastore, wherein each subdirectory of the plurality of subdirectories is designated to a recipient of the plurality of recipients.

5. The system of claim 1, wherein the parser module is operable to store the plurality of recipient files in a plurality of subdirectories of the datastore, and wherein each subdirectory of the plurality of subdirectories is designated to a recipient of the plurality of recipients.

6. The system of claim 5, wherein the transmitter module is operable to generate an email to an address corresponding to a data recipient of the plurality of recipients for each file of the plurality recipient files stored in a subdirectory of the datastore corresponding to that recipient.

7. The system of claim 6, wherein the transmitter module is operable to generate an email at a scheduled time.

8. The system of claim 1, further comprising a zip module adapted to receive the plurality of recipient files, operable to condense the plurality of recipient files into a plurality of zip files.

9. The system of claim 8, wherein the zip module stores the plurality of zip files in a plurality of subdirectories of the data store, and wherein each subdirectory of the plurality of subdirectories is designated to a recipient of the plurality of recipients.

10. The system of claim 9, wherein the transmitter module is operable to generate an email to an address corresponding to a data recipient of the plurality of data recipients for each zip file of the plurality of zip files stored in a subdirectory of the datastore corresponding to that data recipient.

11. The system of claim 10, wherein the transmitter module is operable to generate an email at a scheduled time.

12. The system of claim 1, further comprising an encryption module operable to encrypt the plurality of recipient files or plurality of zip files according to an encryption method and an encryption key and further operable to generate a plurality of encrypted files.

13. The system of claim 12, wherein the encryption module stores the plurality of encrypted files in a plurality of subdirectories of the data store, and wherein each subdirectory of the plurality of subdirectories is designated to a recipient of the plurality of recipients.

14. The system of claim 13, wherein the transmitter module is operable to generate an email to an address corresponding to a data recipient of the plurality of data recipients for each encrypted file of the plurality of encrypted files stored in a subdirectory of the datastore corresponding to that data recipient.

15. The system of claim 14, wherein the transmitter module is operable to generate an email at a scheduled time.

16. A method for automatically transferring Electronic Data Interchange (EDI) data from a host computer to a plurality of recipients, comprising:
recivieng a file of EDI format from a communications network;
parsing recipient data intended for a plurality of recipients from the file of EDI format;
storing the recipient data in a data store;
determining an electronic address of a recipient of the plurality of recipients from the data store; and
sending the recipient data to the electronic address of a recipient.

17. The method of claim 16, further comprising condensing the recipient data into a zip format prior to sending.

18. The method of claim 17, further comprising encrypting the condensed recipient data according to an encryption method and an encryption key prior to sending, wherein the encryption method and the encryption key can be specified by the recipient and stored in the data store.

19. The method of claim 16, wherein the step of determining an electronic address and the step of sending the recipient data can be scheduled by a user.

20. The method of claim 16, wherein the step of parsing recipient data can be configured according to parameters, wherein the parameters are defined by EDI standards, and wherein the parameters can be at least one of a supplier code, a transaction code, and a transaction date.

21. A method of automatically transferring Electronic Data Interchange (EDI) data from a host computer to a plurality of recipients, comprising;
traversing through a plurality of subdirectories of a datastore;
determining an electronic address of a recipient from a subdirectory of the plurality of subdirectories;
extracting a file of EDI format from a subdirectory of the plurality of subdirectories; and
transmitting the file of EDI format to the electronic address of a recipient.

22. A method of claim 21, further comprising condensing the file according to a zip format.

23. A method of claim 22, further comprising encrypting the file according to an encryption method and an encryption key.

24. A method of claim 23, further comprising parsing data from a file format according to EDI protocol standards, and storing the data in a plurality of subdirectories of the datastore; wherein the plurality of subdirectories corresponding to the plurality of recipients.

25. A method of claim 21, further comprising entering a plurality of electronic addresses corresponding to a plurality of recipients and storing the plurality of electronic addresses in a plurality of subdirectories of the datastore.
